(19) United States
(12) Patent Application Publication
(10) Pub. No.: US 2003/0147589 A1
(43) Pub. Date: Aug. 7, 2003

(54) Multiplexer-demultiplexer module having an arrayed waveguide grating

(75) Inventor: Vincent Patoz, Palaiseau (FR)

Correspondence Address: SUGHRUE MION, PLLC, 2100 Pennsylvania Avenue, NW, Washington, DC, 20037-3213, US

(73) Assignee: ALCATEL OPTRONICS

(21) Appl. No.: 10/271,989

(22) Filed: Oct. 17, 2002

(30) Foreign Application Priority Data
Oct. 18, 2001 (FR) 01 13 441

(51) Int. Cl. G02B 6/34; G02B 6/30

(52) U.S. Cl. 385/37; 385/49

(57) ABSTRACT

In an optical module comprising an arrayed waveguide grating multiplexer-demultiplexer component having at least one inlet waveguide and at least one outlet waveguide, the module is integrated and comprises at least one inlet optical fiber and at least one outlet optical fiber, said inlet waveguide presenting an optical coupling interface with the inlet optical fiber and said outlet waveguide presenting an optical coupling interface with the outlet optical fiber, and a thin film filter is inserted directly at the optical coupling interface between the inlet and/or outlet waveguide(s) of the multiplexer-demultiplexer component and the inlet/outlet optical fiber(s) of the module.

The present invention relates to the field of wavelength multiplexer-demultiplexer components, and more particularly to arrayed waveguide grating (AWG) multiplexer-demultiplexers. Such components are conventionally used in multiplexing and/or demultiplexing applications or for wavelength selection applications known as add and drop multiplexing.

### BACKGROUND OF THE INVENTION

FIG. 1 is a diagram of a conventional AWG component 20 integrated on a substrate 10, e.g. a silicon substrate. Inlet waveguides 11 convey light signals at given wavelengths λ₁, λ₂, . . . λₙ into an inlet coupler 12 leading to an array of waveguides 13. The light signals are subjected to phase shifts in the array of waveguides 13 and are subsequently focused by an outlet coupler 14 into outlet waveguides 15. Each optical signal is subjected to the following operations:

diffraction in the inlet coupler 12 which is represented mathematically by the Fourier transform of the signal being diffracted, each waveguide of the array 13 situated at the outlet surface of the coupler 12 receiving a fraction of the diffracted wave;

phase shifts in the array of waveguides 13 which are of various optical path lengths, with the optical path followed in any one waveguide of the array being expressed as a function of the refractive index of the waveguide and as a function of its length; at the outlet from the array of waveguides 13, these phase shifts give rise to interference which is constructive in some particular direction that depends on wavelength; and

focusing the constructive interference of waves coming from the array of waveguides 13 onto the outlet surface of the coupler 14.

Such an AWG is not capable on its own of performing wavelength filtering.

Japanese patent application No. 11 006 928 discloses an AWG associated with components each comprising a thin film filter.

Such thin film filters are known and are made up of a succession of thin films having different refractive indices. The thin film filters disclosed in that document are of the band-pass type and they are therefore suitable for eliminating undesirable wavelengths, specifically for the purpose of avoiding inter-symbol mixing or “crosstalk”.

The thin film filter components are interposed in the outlet waveguides from the AWG, thereby giving rise to additional optical loss.

In addition, in order to receive those components, the AWG substrate has trenches. Inserting components in that way gives rise to manufacturing problems and to reliability problems.

### OBJECT AND SUMMARY OF THE INVENTION

The object of the invention is to provide an optical module including an AWG component and a thin film filter that is capable, depending on the application, of processing wavelengths (or channels) individually or in given spectrum bands, with the module also providing high performance, being reliable, compact, and integrated.

To this end, the present invention provides an optical module comprising:

an arrayed waveguide grating multiplexer-demultiplexer component, said multiplexer-demultiplexer component comprising at least one inlet waveguide and at least one outlet waveguide; and

a thin film filter;

wherein the module is integrated and comprises at least one inlet optical fiber and at least one outlet optical fiber, said inlet waveguide presenting an optical coupling interface with the inlet optical fiber and said outlet waveguide presenting an optical coupling interface with the outlet optical fiber; and

wherein said thin film filter is inserted directly at the optical coupling interface between the inlet and/or outlet waveguide(s) of the multiplexer-demultiplexer component and the inlet and/or outlet optical fiber(s) of the module.

Unlike the prior art, the thin film filter of the invention is not contained in an additional component that is added to the module.

In embodiments, the thin film filter is deposited on the coupling facet of the inlet and/or outlet optical fiber(s) of the module, or on the coupling facet of the inlet and/or outlet waveguide(s) of the component.

The coupling facet thus acts as a substrate for the thin film filter of the invention.

According to a feature, the optical coupling interfaces between the inlet and/or outlet waveguide(s) of the multiplexer-demultiplexer component and the inlet and/or outlet optical fiber(s) of the module are adhesive interfaces.

In an advantageous embodiment, the AWG multiplexer-demultiplexer component is integrated on a monolithic substrate and the optical module is integrated on a hybrid substrate.

In a first preferred embodiment, said thin film filter is suitable for selecting a single diffraction order from the outlet signal of said component.

A direct consequence of the optical signals diffracting in the array of waveguides in a conventional AWG is that the spectrum of each optical signal in the outlet waveguides is reproduced over different orders of diffraction. The phase shifting introduced by the array of waveguides is limited to modulo 2π.

Thus, as shown in FIG. 2, for a 16-channel demultiplexer the inlet signals can be transmitted in demultiplexed form at the outlet over a plurality of diffraction orders at a wavelength interval corresponding to a parameter of the AWG known as the free spectral range (FSR). This parameter represents the spectral spacing between two successive diffraction orders and depends on the hardware properties of the AWG, and in particular on the geometry of the couplers 12 and 14.

Unfortunately, this repeating of the optical spectrum can be a drawback in certain applications. In particular, when different signals conveying different data propagate at respective wavelengths correspond to λ₁+FSR and to λ₁, and when these signals are demultiplexed and delivered to the same outlet waveguide.

Thus, the spectral response of the thin film filter of the invention is advantageously adjusted to allow only one diffraction order to be output from the AWG. In this first embodiment, the other orders are eliminated, i.e. they are not reused.

By way of example, starting from an inlet signal made up of wavelengths in two transmission bands C (1530 nanometers (nm) to 1560 nm approximately) and L (1565 nm to 1610 nm, approximately) the module demultiplexes and passes only those wavelengths that lie in band C.

In a second preferred embodiment, said thin film filter is suitable for allowing a group of wavelengths to be forwarded and is suitable for reflecting distinct wavelengths of said group of wavelengths.

For example, starting from an inlet signal made up of wavelengths in one of the transmission bands C and L, the module will demultiplex and pass only a group of wavelengths in said band C or L, e.g. four or eight wavelengths in a common sub-band, and it will reflect the other wavelengths so that they can be reused. By way of example, these other wavelengths are redirected by means of an optical circulator placed upstream of or integrated in the module of the invention.

Depending on the application, the optical module is a wavelength multiplexer-demultiplexer module and/or an optical module for wavelength selection.

### BRIEF DESCRIPTION OF THE DRAWINGS

The features and advantages of the present invention appear more clearly on reading the following description given by way of non-limiting illustration, and made with reference to the accompanying figures in which:

FIG. 1, described above, shows the conventional structure of an AWG multiplexer-demultiplexer;

FIG. 2, described above, is a diagram showing the demultiplexing spectrum from an AWG multiplexer-demultiplexer; and

FIGS. 3a and 3b are diagrams showing possible implementations of a preferred embodiment of the invention.

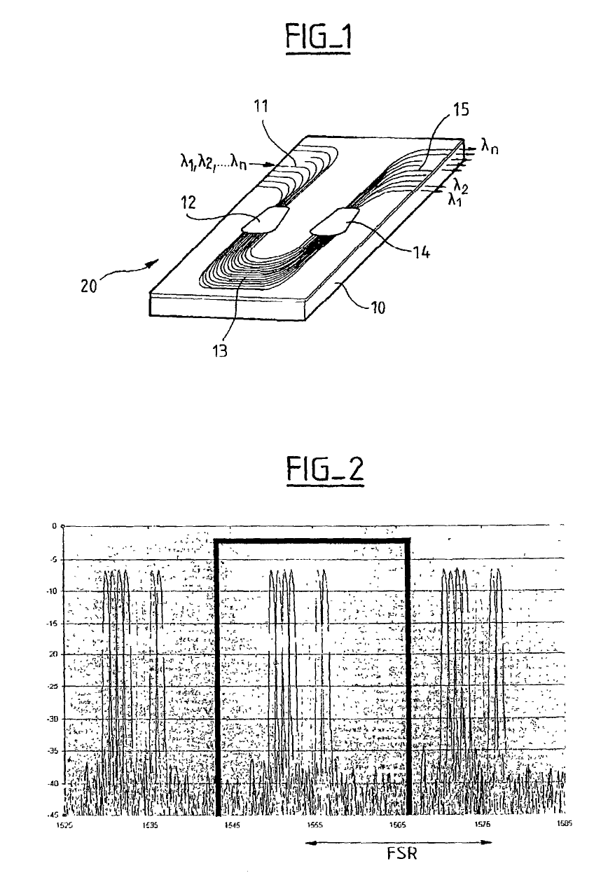

### MORE DETAILED DESCRIPTION

The invention proposes making an integrated optical module including both an AWG multiplexer-demultiplexer component and a thin film filter, serving to pass a signal to its outlet only for certain wavelengths of inlet signal.

Such an optical module comprises at least one inlet optical fiber (a plurality if it is a multiplexer) and at least one outlet optical fiber (a plurality if it is a demultiplexer), these optical fibers being coupled to an AWG multiplexer-demultiplexer component.

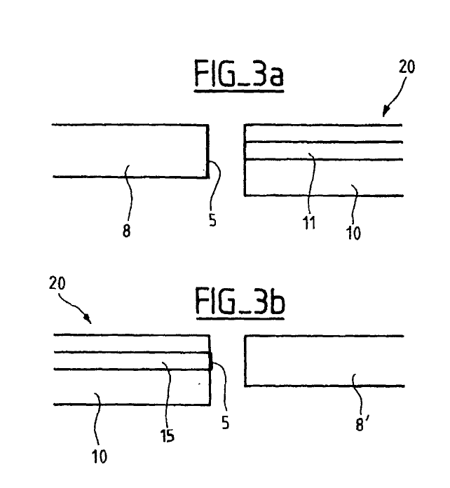

FIGS. 3a and 3b are diagrams showing the inlet and outlet optical coupling interfaces in a preferred embodiment of the invention.

As described above, the AWG 20 has at least one inlet waveguide 11 presenting an optical coupling interface with an inlet optical fiber 8, and at least one outlet waveguide 15 presenting an optical coupling interface with an outlet optical fiber 8′.

Such optical coupling interfaces are generally secured by adhesive. The optical fibers 8, 8′ are circular in section whereas the waveguides 11 and 15 of the AWG are rectangular in section. In addition, since the AWG component 20 is monolithically integrated on a substrate 10, welding is consequently difficult to implement.

The invention proposes inserting a thin film filter 5 directly in the optical coupling interface between the inlet optical fiber 8 or the outlet optical fiber 8′ and the inlet waveguide 11 or the outlet waveguide 15 of the AWG.

Thin film filters comprise a succession of thin films having different refractive indices that are deposited by vacuum spraying or evaporating using techniques that are well understood by the person skilled in the art. By varying the number, the thickness, and the refractive indices of the superposed layers, it is possible to determine the spectral response of the filter: the thin film filter 5 is designed so as to be able to select the appropriate diffraction order of the outlet signal from the AWG component.

In a variant, the thin film filter is designed so as to allow a group of wavelengths to be passed while reflecting wavelengths that do not form part of said group of wavelengths.

The thin film filter 5 is advantageously deposited on the coupling facet of the inlet or outlet optical fiber(s) 8 or 8′ of the module. The coupling facet of an optical fiber is often cleaved and generally carries antireflection treatment implemented using a thin film deposition technique identical to that described for making a thin film filter.

Nevertheless, as shown in FIG. 3b, the thin film filter 5 could also be deposited on the coupling facet of the inlet or outlet waveguide(s) 11 or 15 of the component 20.

The thin film filter 5 is not contained in a component that is separate from the module of the invention since it is directly integrated in the inlet or outlet optical coupling interface. Thus, since the AWG is integrated on a monolithic substrate, hybrid integration with inlet and outlet optical fibers serves to provide the integrated module of the invention.

What is claimed is:

1. An optical module comprising:
an arrayed waveguide grating multiplexer-demultiplexer component, said multiplexer-demultiplexer component comprising at least one inlet waveguide and at least one outlet waveguide; and
a thin film filter;
wherein the module is integrated and comprises at least one inlet optical fiber and at least one outlet optical fiber, said inlet waveguide presenting an optical coupling interface with the inlet optical fiber and said outlet waveguide presenting an optical coupling interface with the outlet optical fiber; and
wherein said thin film filter is inserted directly at the optical coupling interface between the inlet and/or outlet waveguide(s) of the multiplexer-demultiplexer component and the inlet and/or outlet optical fiber(s) of the module.

2. An optical module according to claim 1, wherein the thin film filter is deposited on the coupling facet of the inlet and/or outlet optical fiber(s) of the module.

3. An optical module according to claim 1, wherein the thin film filter is deposited on the coupling facet of the inlet and/or outlet waveguide(s) of the component.

4. An optical module according to claim 1, wherein the optical coupling interfaces between the inlet and/or outlet waveguide(s) of the multiplexer-demultiplexer component and the inlet and/or outlet optical fiber(s) of the module are adhesive interfaces.

5. An optical module according to claim 1, wherein the AWG multiplexer-demultiplexer component is integrated on a monolithic substrate.

6. An optical module according to claim 1, the optical module being integrated on a hybrid substrate.

7. An optical module according to claim 1, wherein said thin film filter is suitable for selecting a single diffraction order from the outlet signal of said component.

8. An optical module according to claim 1, wherein said thin film filter is suitable for allowing one group of wavelengths to be transmitted and is suitable for reflecting wavelengths that do not form part of said group of said wavelengths.

9. An optical module according to claim 1, constituting a wavelength multiplexing/demultiplexing optical module.

10. An optical module according to claim 1, constituting a wavelength selection optical module.
